(19) United States
(12) Patent Application Publication
(10) Pub. No.: US 2002/0035888 A1
(43) Pub. Date: Mar. 28, 2002

(54) Steering wheel assembly, and corresponding central pad, shell-type trim element and motor vehicle

(76) Inventors: Frederick Bois, Belfort (FR); Thomas Prevost, Montbeliard (FR)

Correspondence Address: YOUNG & THOMPSON, 745 SOUTH 23RD STREET 2ND FLOOR, ARLINGTON, VA, 22202

(21) Appl. No.: 09/956,824

(22) Filed: Sep. 21, 2001

(30) Foreign Application Priority Data
Sep. 22, 2000 (JP) 00 12115

(51) Int. Cl. B62D 1/04

(52) U.S. Cl. 74/552

(57) ABSTRACT

This assembly for a motor vehicle comprises a steering column comprising a steering shaft capable of turning about a longitudinal axis, a steering wheel (3) comprising an outer rim (6) and at least one spoke (8) connected by a first end (20) to the rim and by a second end (21) to the rear end of the steering shaft to drive it in rotation about its longitudinal axis, a fixed central pad (4) placed substantially at the center of the steering wheel at the rear of the second end of the or of each spoke and connected to the rear end of the steering column so as to be fixed in terms of rotation when the steering shaft is turning. The or each spoke comprises an axial change in direction (22) towards the rear and the central pad (4) Comprises an substantially annular front axial skirt which delimits a central cavity (27), the skirt (26) extending axially inside the or each change in direction (22) of the central cavity (27) accommodating the second end (21) of the or each spoke so as to conceal the connection between the steering wheel (3) and the steering shaft.

The present invention relates to a steering assembly for a motor vehicle, of the type comprising:

a steering column comprising a steering shaft capable of turning about a longitudinal axis,

a steering wheel comprising an outer rim and at least one spoke connected by a first end to the rim and by a second end to the rear end of the steering shaft to drive it in rotation about its longitudinal axis,

a fixed central pad placed substantially at the centre of the steering wheel at the rear of the second end of the or of each spoke and connected to the rear end of the steering column so as to be fixed in terms of rotation when the steering shaft is turning.

An assembly such as this allows the steering shaft to be driven in rotation by the steering wheel while at the same time keeping the central pad fixed.

A central pad such as this generally groups together several accessories, including an airbag module, a switch for operating an audible alert device, and other members for operating various functional items of equipment of the vehicle.

An assembly of the aforementioned type is known, for example, from document EP-0 825 089. In the assembly of that document, the connection between the rear end of the steering shaft and the second ends of the spokes of the steering wheel is by screws. Each spoke extends from its second end axially rearwards and radially outwards, substantially forming an arc of a circle. The front face of the central pad facing the spokes has a corresponding profile. The steering assembly further comprises a shell-type trim element arranged in front of the steering wheel to conceal the rear end of the steering column. This shell-type trim element has a rear face which faces second ends of the spokes and is substantially plane and transversal to the longitudinal axis.

The connection between the steering wheel and the rear end of the steering shaft is visible from the lateral sides of the steering assembly. This is considered to detract from the aesthetic appearance of the steering assembly.

One object of the invention is to improve the aesthetic appearance of an assembly of the aforementioned type by limiting the possibility that an observer has to see, from outside the assembly, the connection between the steering wheel and the rear end of the steering shaft.

To this end, the subject of the invention is an assembly of the aforementioned type, characterized in that the or each spoke comprises a portion axially turned back rearwards and the central pad comprises an substantially annular front axial skirt which delimits a central cavity, the skirt extending axially inside the or each turned back portion of the central cavity accommodating the second end of the or each spoke so as to conceal the connection between the steering wheel and the steering shaft.

According to alternatives:

it further comprises a shell-type trim element placed at the front of the second end of the or each spoke in order to conceal the rear end of the steering column, and an substantially annular groove is formed in the shell and the or each turned back portion is accommodated in the groove,

the turned back portion of the or each spoke has an axial length between its bottom and its radially interior end in excess of about 15 mm, and the central cavity has an axial depth in excess of about 10 mm.

A further subject of the invention is a steering wheel for a steering assembly as defined hereinabove, characterized in that its or each of its spoke(s) has a portion axially turned back in a direction intended to be oriented towards the rear.

According to an alternative, the turned back portion of the or each spoke has an axial length between its bottom and its radially interior end in excess of about 15 mm.

A further subject of the invention is a fixed central pad for a steering assembly as defined hereinabove, characterized in that it comprises an substantially annular axial skirt intended to be oriented forwards, to extend inside the or each change in direction, and delimiting a central cavity to accommodate the second end of the or each spoke.

According to an alternative, the cavity has an axial depth in excess of about 10 mm.

A further subject of the invention is a shell-type trim element for an assembly as defined hereinabove, characterized in that an substantially annular groove intended to be oriented towards the rear to accommodate the bottom of the or of each change in direction is formed in the shell-type trim element.

According to an alternative, the groove has an axial depth in excess of about 5 mm.

A further subject of the invention is a motor vehicle, characterized in that it comprises a steering assembly as defined hereinabove.

The invention will be better understood upon reading the description which will follow, which is given solely by way of example and with reference to the appended drawings, in which;

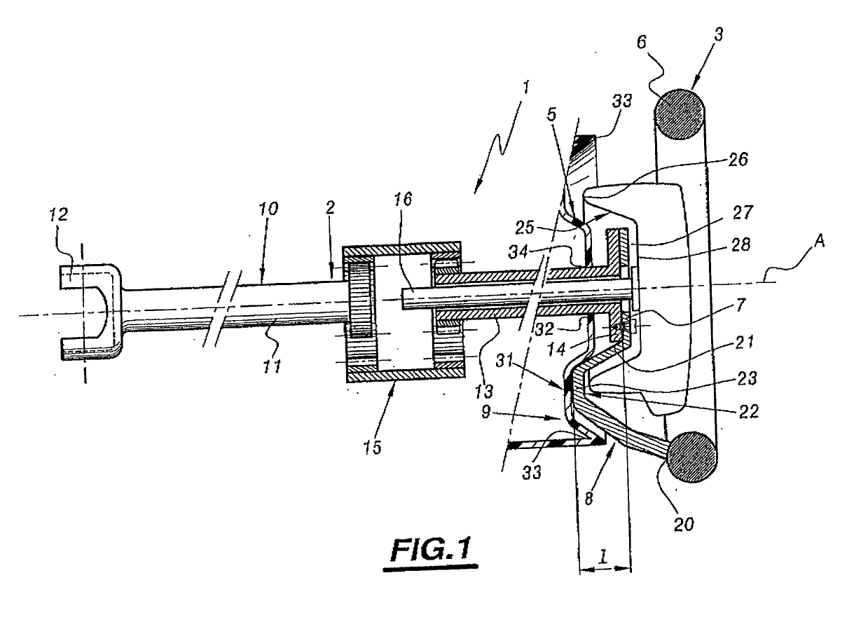

FIG. 1 is a partial, schematic and lateral view in part section of a steering assembly according to the invention,

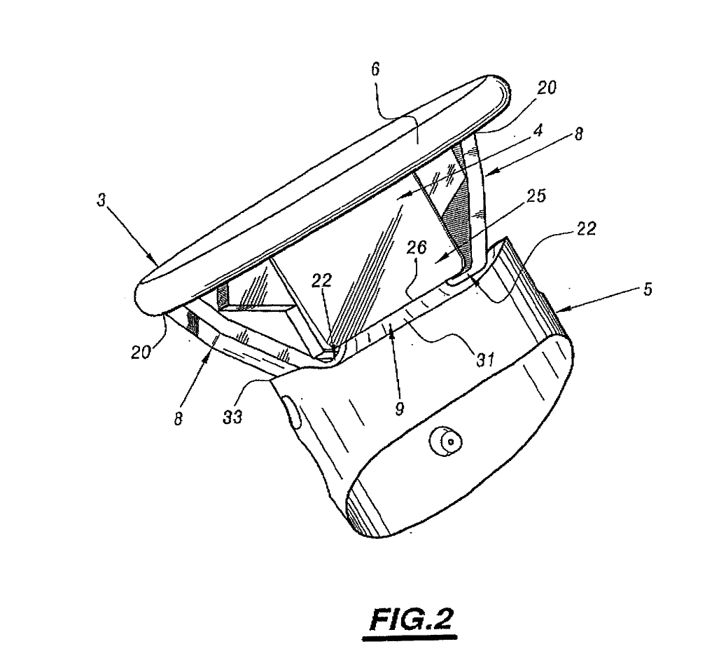

FIG. 2 is a schematic perspective view of the steering wheel, of the fixed central pad and of the shell-type trim element of the steering assembly of FIG. 1,

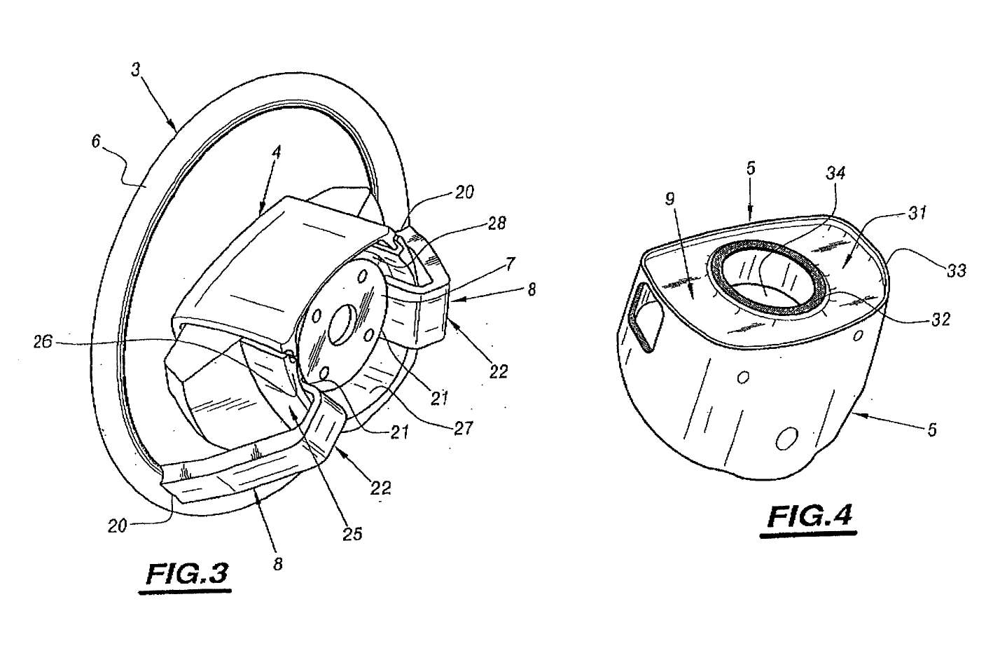

FIG. 3 is a schematic perspective view of the steering wheel and of the fixed central pad of the steering assembly of FIG. 1, and

FIG. 4 is a schematic perspective view of the shell-type trim element of the steering assembly of FIG. 1.

In what follows, the orientations used are the conventional orientations of a motor vehicle. The terms “front” and “rear” are thus to be understood with respect to the position of a driver.

FIG. 1 depicts a steering assembly 1 of a motor vehicle. This assembly 1 has a longitudinal axis A and comprises a steering column 2, a steering wheel 3, a fixed central pad 4 and a shell-type trim element 5. The steering wheel 3, the pad 4 and the shell-type trim element 5 are mounted to the rear of the steering column 2.

The steering wheel 3 comprises an outer annular rim 6, a central hub 7 in the form of a disc, and spokes 8 connecting the hub 7 to the rim 6. In the example depicted, there are two spokes 8.

The fixed central pad 4 comprises, in the conventional way, an airbag module, not depicted, and possibly a switch for operating an audible alert device, together with other members for operating other functional items of equipment of the vehicle.

The shell-type trim element 5 is a sleeve which is open at its front end and closed at its rear end by a rear face 9. The shell 5 receives the rear end of the steering column 2 via its open front end, so as to conceal this column. The front end of the shell-type trim element 5 is accommodated in an orifice made in the dashboard (not depicted) of the motor vehicle.

The steering column 2 comprises a steering shaft 10 that can rotate about the longitudinal axis A. The steering shaft 10 itself comprises a front portion 11 equipped at its front end with a joint half (yoke) 12 connected to the remainder of the steering mechanism incorporating the assembly 1, and a rear portion 13, at the rear end 14 of which the steering wheel 3 is mounted by virtue of its hub 7. This mounting may, for example, be by means of screws passing through orifices made in the hub 7. The rear portion 13 of the steering shaft 10 passes through the rear end of the shell-type trim element 5.

The steering column 2 further comprises a device with gearing 15 arranged between the front portion 11 and rear portion 13 of the steering shaft 10, and a fixed support 16 arranged inside the rear portion 13 of the steering shaft 10 and to the rear of which the central pad 4 is mounted. As previously, this mounting may for example be by means of screws.

The steering assembly 1 is an assembly with a fixed central pad which, by virtue of the gearing device 15 and of the fixed support 16, allows a rotational movement of the rear portion 13, produced by the steering wheel 3, to be transmitted to the front portion 11 of the steering shaft 10 while the central pad 4 remains fixed.

More specifically, the assembly 1 depicted in FIG. 1 is similar to the one described in document EP-0 825 089, where more detailed information can be found. It is to be noted that numerous other types of steering assembly with a fixed central pad are known and can thus be used in the context of the invention.

According to the invention, each spoke 8, which is connected by a first end 20 to the rim 6 and by a second end 21 to the central hub 7, has a portion 22 axially turned back rearwards and located near the second end 21. The axial length of this turned back portion, that is to say the length l separating the bottom 23 of the turned back portion 22 from the second end 21 of the spoke 8 in question is substantially 30 mm and preferably in excess of 15 mm.

The front face 25 of the fixed central pad 4, which faces the central hub 7 and the spokes 8 of the steering wheel 3, comprises an annular axial skirt 26, centred on the axis A and projecting forward. This skirt 26 delimits, in the front face 25, a circular cavity 27 which extends axially forward and which is substantially centred on the axis A. The cavity 27 has an axial depth of about 25 mm, and preferably in excess of 10 mm.

This cavity 27 accommodates the central hub 7 and the second ends 21 of the spokes 8 of the steering wheel 3. The hub 7 is located near the bottom 28 of the cavity 27 and the skirt 26 extends axially inside the change of direction 22, practically as far as its bottom 23.

The front face 25 of the fixed central pad 4 therefore substantially follows the profile of the spokes 8 near their ends 21 and their turned back portions 22.

A groove 31 oriented towards the rear is formed in the rear face 9 of the shell-type trim element 5. This groove 31 is substantially axisymmetric about the axis A and delimits an interior annular rim 32 and an exterior rim 33 which project towards the rear. The exterior rim 33 is of substantially annular shape flattened on its lower and upper portions. The axial depth of the groove 31, that is to say between its bottom and the rim 33, is in excess of 10 mm, and preferably in excess of 5 mm.

A circular orifice 34 is formed at the centre of the rear face 9. This orifice is bordered by the interior rim 32 and, with a small amount of clearance, accommodates the rear portion 13 of the steering shaft 10 to allow it to turn about its longitudinal axis A.

The rim 32 is arranged in the cavity 27 of the fixed central pad 4, axially to the rear of the front end of the skirt 26.

The groove 31 accommodates the bottoms 23 of the turned back portions 22 of the spokes 8. The exterior rim 33 is situated axially to the rear of the front end of the front skirt 26 of the central pad 4.

By virtue of the groove 31, the rear race 9 of the shell 5 substantially follows the profile of the spokes 8 near their ends 21 and their turned back portions 22.

By virtue of the shapes of the spokes 8, of the central pad 4 and of the shell 5, the connection between the central hub 7 and the rear end 14 of the steering shaft 2 is not visible from outside the assembly 1, as can be seen in FIG. 2.

In this way, the aesthetic appearance of the steering assembly 1 is improved without the addition of additional parts.

It will indeed be noted that the concealment effect can also be obtained without using a shell-type trim element 5 that has a groove 31, if the arrangement inside the cabin near the steering wheel 3 and the central pad 4 is such that an occupant of the vehicle cannot position himself forward of the skirt 26 of the central pad 4 to look back into the cavity 27 of the central pad 4.

1. Steering assembly (1) for a motor vehicle, of the type comprising:
a steering column (2) comprising a steering shaft (10) capable of turning about a longitudinal axis (A)
a steering wheel (3) comprising an outer rim (5) and at least one spoke (8) connected by a first end (20) to the rim and by a second end (21) to the rear end (14) of the steering shaft to drive it in rotation about its longitudinal axis (A),
a fixed central pad (4) placed substantially at the centre of the steering wheel at the rear of the second end of the or of each spoke and connected to the rear end of the steering column so as to be fixed in terms of rotation when the steering shaft (10) is turning, characterized in that the or each spoke comprises a portion axially turned back rearwards and the central pad (4) comprises an substantially annular front axial skirt which delimits a central cavity (27), the skirt (26) extending axially inside the or each turned back portion (22) and the central cavity (27) accommodating the second end (21) of the or each spoke so as to conceal the connection between the steering wheel (3) and the steering shaft (10).

2. Assembly according to Claim 1, characterized in that it further comprises a shell-type trim element (5) placed at the front of the second end (21) of the or each spoke in order to conceal the rear end of the steering column (2), and in that an substantially annular rear groove (31) is farmed in the shell (5) and the or each change in direction is accommodated in the groove (31).

3. Assembly according to claim 1, characterized in that the turned back portion (22) of the or each spoke (8) has an axial length (1) between its bottom and its radially interior end in excess of about 15 mm, and the central cavity (27) has an axial depth in excess of about 10 mm.

4. Steering wheel for a steering assembly according to claim 1, characterized in that its or each of its spoke(s) has a portion axially turned back in a direction intended to be oriented towards the rear.

5. Steering wheel according to claim 4, characterized in that the turned back portion (22) of the or each spoke has an axial length between its bottom and its radially interior end in excess of about 15 mm.

6. Central pad for a steering assembly according to claim 1, characterized in that it comprises an substantially annular axial skirt (26) intended to be oriented forwards, to extend inside the or each turned back portion (22), and delimiting a central cavity to accommodate the second end of the or each spoke (8).

7. Central pad according to Claim 6, characterized in that the cavity has an axial depth in excess of about 10 mm.

8. Shell-type trim element for an assembly according to claim 2, characterized in that an substantially annular groove (31) intended to be oriented towards the rear to accommodate the bottom (23) of the or of each turned back portion (22) is formed in the shell-type trim element (5).

9. Shell-type element according to claim 8, characterized in that the groove has an axial depth in excess of about 5 mm.

10. Motor vehicle, characterized in that it comprises a steering assembly according to any one of claims 1 to 3.
